(19) United States
(12) Patent Application Publication
(10) Pub. No.: US 2026/0211149 A1
(43) Pub. Date: Jul. 23, 2026

(54) BORHOLE CORRECTION OF FORMATION PHOTOELECTRIC FACTORS

(71) Applicant: SCHLUMBERGER TECHNOLOGY CORPORATION, Sugar Land, TX (US)

(72) Inventor: Bo YU, Sugar Land, TX (US)

(21) Appl. No.: 19/140,375

(22) PCT Filed: Dec. 14, 2023
(86) PCT No.: PCT/US2023/084029

§ 371 Date: Jun. 18, 2025

Related U.S. Application Data
(60) Provisional application No. 63/478,277, filed on Jan. 3, 2023.

(51) Int. Cl. G01V 5/12; E21B 47/024; E21B 49/00

(52) U.S. Cl. CPC G01V 5/12; E21B 47/024; E21B 49/00

(57) ABSTRACT

A method for correcting photoelectric logging measurements includes acquiring a photoelectric factor image including photoelectric factor measurements in at least first and second azimuthal sectors in a borehole. The photo electric factor image is processed using a system of equations to compute a photoelectric factor of a formation through which the borehole penetrates and photoelectric factor of the drilling fluid in the borehole.

### CROSS REFERENCE TO RELATED APPLICATIONS

This application claims the benefit of U.S. Provisional Application No. 63/478,277, entitled “BORHOLE CORRECTION OF FORMATION PHOTOELECTRIC FACTORS,” filed Jan. 3, 2023, the disclosure of which is hereby incorporated herein by reference.

### BACKGROUND

Logging measurements have been used in the oilfield industry for many decades to evaluate various properties of subterranean formations. For example, litho-density logging tools may be configured to measure the formation photoelectric factor (Pₑ), which is related to the average atomic number of the elements in and surrounding the borehole. In ideal environments, the borehole fluids are made up of and include mostly low atomic number elements such that Pₑ may largely be measure of the atomic number of the formation rock.

Pₑ logs may be used to evaluate formation minerology and lithology. Sandstone is known to have a low Pₑ, while dolomites, limestone, clays, and iron-bearing minerals are known to have higher Pₑ values. However, in practice, Pₑ measurements may be corrupted by the drilling fluid in the borehole. For example, in barite (or other heavy mineral) containing drilling fluids the measured Pₑ can be significantly higher than would be observed from the formation rock such that the measurements may not give an accurate indication of the formation atomic number or lithology. This effect can be especially pronounced when the logging measurements are made at a large standoff distance from the borehole wall.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including one disclosed litho-density logging tool.

FIG. 2 schematically depicts one example embodiment of the litho-density logging tool shown on FIG. 1.

FIG. 3 depicts a flow chart of one example method for obtaining a corrected photoelectric factor.

FIGS. 4A and 4B (collectively FIG. 4) depict a cross section of a logging tool centered (4A) and eccentered (4B) in a borehole.

FIG. 5 depicts a flow chart of another example method for obtaining a corrected photoelectric factor.

FIG. 6 depicts a schematic of a borehole intersecting a bed boundary.

FIGS. 7A and 7B (collectively FIG. 7) depict plots of simulated raw volumetric photoelectric factor measurements versus depth (7A) and corresponding depth corrected (depth aligned) volumetric photelectric factor measurements (7B) for upper, right, bottom, and left quadrants.

FIGS. 8A-8H depict plots of a simulated volumetric photoelectric factor versus a simulation number for a first example.

FIGS. 9A-9F depict simulated logs including three tracks plotting simulated Pₑ, U, and mud Pₑ and U versus measured depth for a second example.

FIG. 10 depicts a simulated log including three tracks plotting simulated Pₑ, U, and mud Pₑ and U versus measured depth for a third example.

### DETAILED DESCRIPTION

Embodiments of this disclosure include systems and methods for making borehole corrected photoelectric logging measurements. One example method includes emitting gamma rays into a borehole while rotating a logging tool therein. Corresponding gamma rays are detected and processed to compute a photoelectric factor image including a photoelectric factor measurement in each of at least first and second azimuthal sectors. The photoelectric factor image is further processed using a system of equations to compute a photoelectric factor of a formation through which the borehole penetrates and photoelectric factor of the drilling fluid in the borehole.

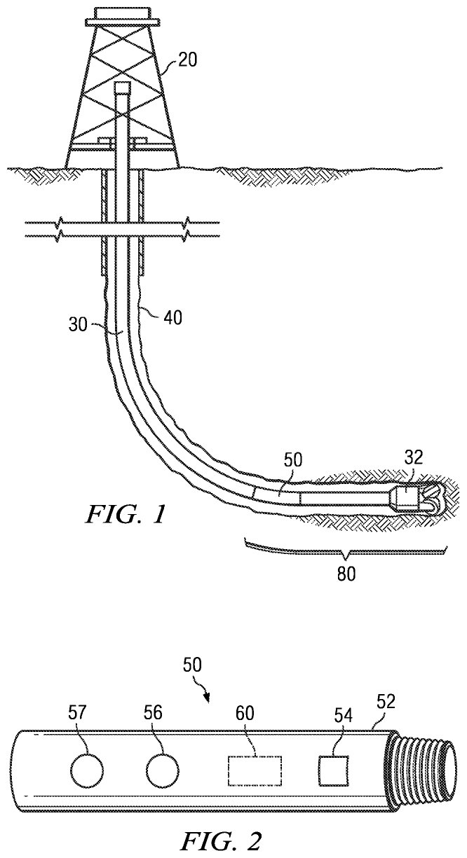

FIG. 1 depicts an oil or gas drilling rig 20 including an example litho-density logging tool 50. In the depicted embodiment a land rig 20 is positioned over an oil or gas formation (not shown). The rig may include a derrick and a hoisting apparatus (not shown) for raising and lowering a drill string 30, which, as shown, extends into borehole 40 and includes a drill bit 32 deployed at the lower end of a bottom hole assembly (BHA) 80. The BHA 80 further includes the disclosed litho-density logging tool 50.

It will be understood that the deployment illustrated on FIG. 1 is merely an example. Drill string 30 and/or BHA 80 may include substantially any suitable downhole tools, for example, including a steering tool such as a rotary steerable tool, a downhole telemetry system, and one or more additional MWD and/or LWD tools including various sensors for sensing downhole characteristics of the borehole and the surrounding formation. The disclosed embodiments are by no means limited to any particular drill string or BHA configuration.

It will be further understood that the disclosed embodiments are not limited to use with a land rig, but are equally well suited for use with either onshore or offshore subterranean operations. As is known to those of ordinary skill, offshore rigs commonly include a platform deployed atop a riser that extends from the sea floor to the surface. The drill string extends downward from the platform, through the riser, and into the borehole through a blowout preventer (BOP) located on the sea floor. The disclosed embodiments are not limited in these regards.

FIG. 2 schematically depicts one example embodiment of litho-density logging tool 50. The tool 50 includes a gamma ray source 54 deployed in a tool collar 52 (or an internal mandrel). The tool collar 52 and optional internal mandrel may be referred to collectively herein as a tool body. The gamma ray source 54 may include substantially any suitable source of gamma rays, for example including a Cesium-137 source that emits 0.66 MeV gamma rays. The Cesium-137 source is commonly used in the industry. Logging tool 50 further includes at least one gamma ray detector axially offset from the source 54 in the tool body, for example, first and second axially offset gamma ray detectors 56, 57 in the example embodiment depicted. In example embodiments including first and second gamma ray detectors, the detectors may be referred to as near and far gamma ray detectors 56, 57, being respectively near to and far from the source 54. The gamma ray detector(s) 56, 57 may include substantially any suitable gamma ray detector, for example, including a sodium iodide (Nal) scintillator crystal and a photomultiplier. Such gamma ray detectors are also commonly used in the industry. While not depicted on FIG. 2, it will be appreciated that logging tool 50 may further include one or more neutron detectors, for example, including a conventional ³He proportional counter for measuring thermal (or other) neutrons.

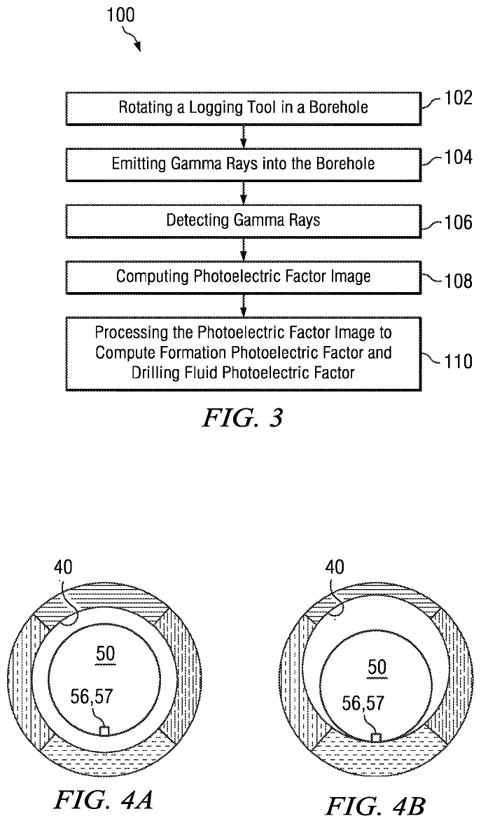

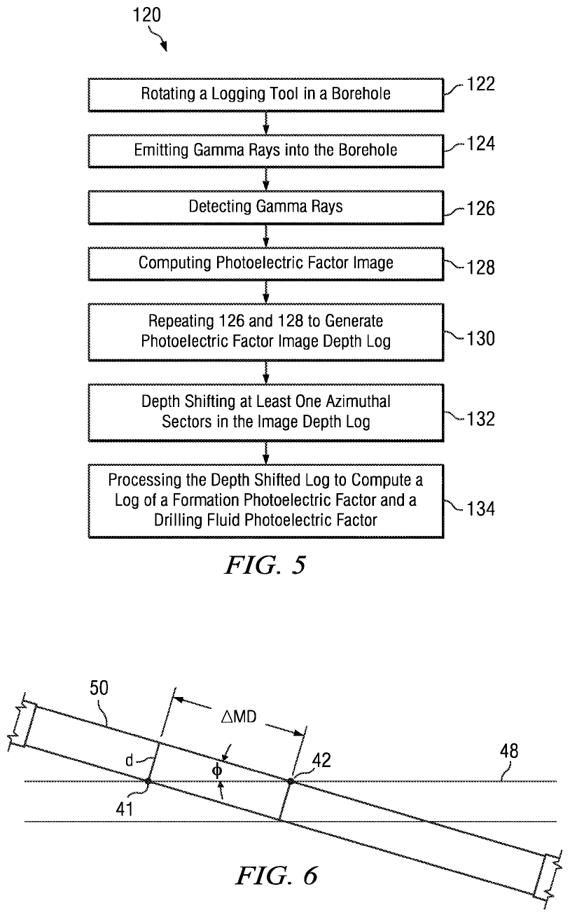

With continued reference to FIG. 2, logging tool 50 may further include an electronic controller 60 including one or more processors (e.g., microprocessors) and electronic memory deployed in the tool body. The controller 60 may include processor executable instructions (e.g., stored in memory) configured to receive electrical/electronic signals from the gamma ray detector(s) 56, 57 and to process the signals to compute a photoelectric factor or a volumetric photoelectric factor. The controller 60 may further include processor executable instructions configured to execute disclosed methods steps described in more detail below (e.g., with respect to FIGS. 3 and 5 and Eqns. (2), (2a), and 2(b)). It will, of course, be understood that the disclosed embodiments are not limited to the use of or the configuration of any particular controller hardware, firmware, and/or software.

As described in more detail below the disclosed embodiments are directed to methods and systems for determining a corrected photoelectric factor (or volumetric photoelectric factor) including a photoelectric factor of a formation and a photoelectric factor of drilling fluid. The corrected photoelectric factor may be determined (e.g., computed) using substantially any suitable processor, for example, located at the surface or in the downhole logging tool (e.g., via processor 60 in logging tool 50). In certain advantageous embodiments, the corrected photoelectric factor may be computed via a downhole processor and may be stored in downhole memory and/or transmitted to the surface via conventional telemetry techniques.

Logging tool 50 or BHA 80 may further include an azimuth sensor (not shown) configured to measure the azimuth (also referred to in the art as the toolface angle) of the gamma ray detector(s) 56,57 while rotating (e.g., during drilling). Suitable azimuth sensors are well known and commonly include one or more accelerometers, magnetometers, and/or gyroscopic sensors. Logging tool 50 or BHA 80 may still further include a caliper sensor and/or a standoff sensor configured to measure the borehole diameter, cross-sectional shape, and/or the standoff distance of the gamma ray detector(s) 56,57 from the borehole wall. Suitable caliper sensors and standoff sensors are well known and commonly include an ultrasonic pulse-echo sensor configured to transmit an ultrasonic pulse and receive the corresponding echo from the borehole wall. The disclosed embodiments are, of course, not limited to any particular azimuth sensor, caliper sensor, and/or standoff sensor configuration.

With still further reference to FIG. 2, it will be appreciated that gamma rays emitted by the gamma ray source 54 undergo Compton scattering in the borehole drilling fluid and formation rock and thereby lose energy. The Compton scattering events can also change the propagation direction of the gamma rays such that the scattered gamma rays may be detected at the gamma ray sensor(s) 56, 57. At energies below about 0.2 MeV, the gamma rays can be completely absorbed by the atoms in the drilling fluid and formation rock. This absorption is referred to as photoelectric absorption and is understood to be a completely different process than Compton scattering.

During a litho-density logging operation, gamma ray count rates are commonly measured in at least first and second, high and low energy windows. Measured count rates in the high energy window (so called hard gamma rays) are taken as a measure of Compton scattering and the electron density of the material(s) through which the gamma rays have propagated. Measured count rates in the low energy window (so called soft gamma rays) are indicative of the electron density of the material(s) and photoelectric absorption or the photo-electric capture cross-section of the material(s). In practice, low energy gamma ray counts (e.g., less than 0.2 MeV) are processed to compute a photoelectric factor (also referred to in the industry as a photoelectric absorption factor or a photoelectric absorption index) using mathematical techniques known to those of ordinary skill in the industry.

The photoelectric factor Pₑ is commonly defined via the following mathematical relationship:

$${P}_{e} ≡ \frac{1}{K} \frac{{σ}_{e}}{Z}$$

where σₑ represents the photoelectric cross section, Z represents the atomic number (the number of electrons) or average atomic number of the material(s) through which the gamma rays propagate, and K represents a coefficient that depends on the energy at which the photoelectric absorption is observed. The photoelectric factor Pₑ describes the likelihood that a gamma ray will be photoelectrically absorbed per electron of the atoms in the material(s).

As is known to those of ordinary skill in the art, Pₑ may be correlated with atomic number using the following empirical relationship:

$${P}_{e} = {( \frac{Z}{10} )}^{3.6}$$

Owing to its strong relationship to the average atomic number Z, Pₑ is commonly used in formation lithology identification, with sandstone having a low Pₑ and dolomites, limestone, clays, and iron-bearing minerals having higher Pₑ values. In practical petrophysics applications, a volumetric or density weighted photoelectric factor U is commonly used and is defined as follows: U=Pₑρₑ, where ρₑ represents the electron density of the material(s) that may be determined for example, via measuring hard gamma ray count rates. For the purposes of this disclosure both ρₑ and U are sometimes referred to as a photoelectric factor.

While Pₑ and/or U measurements may provide for good lithology identification, the raw measurements can be corrupted by heavy minerals such as barite (barium sulfate) in the drilling fluid. For example, depending on the barite concentration in the drilling fluid, measured Pₑ values have been observed to be up to 60 times higher than corresponding formation Pₑ values. This overshadowing of the formation Pₑ values can strongly interfere with subsequent lithology evaluation (or even render the measured Pₑ values useless). There is a need to correct measured Pₑ and/or U to remove borehole and other drilling fluid effects and to obtain a corrected photoelectric factor that more accurately represent the photoelectric factor of the formation (e.g., referred to herein as U_{f}).

On aspect of the disclosed embodiments was the realization that a corrected photoelectric factor may be obtained by processing azimuthal photoelectric factor measurements made while the logging tool rotates in the borehole (also referred to herein as photoelectric factor images). FIG. 3 depicts a flow chart of one example method 100 for obtaining a corrected photoelectric factor. Method 100 includes rotating a logging tool in a borehole at 102 (e.g., while drilling or reaming). Gamma rays may be emitted into the borehole while rotating at 104 (e.g., via a Cesium-137 gamma ray source, as described above, or another type of gamma-ray or x-ray source). Gamma rays are detected at one or more gamma ray detectors at 106 and processed to compute a photoelectric factor image having a corresponding photoelectric factor value in each of a plurality of (at least first and second) azimuthal sectors about the borehole at 108. The photoelectric factor image computed at 108 may then be further processed at 110 to compute a corrected photoelectric factor. As described in more detail below, in certain embodiments the corrected photoelectric factor may include a first photoelectric factor of the formation surrounding the borehole and a second photoelectric factor of drilling fluid in the borehole.

FIGS. 4A and 4B (collectively FIG. 4) depict a cross section of logging tool 50 centered (4A) and eccentered (4B) in a borehole (e.g., borehole 40 in FIG. 1). In the example embodiment depicted, the gamma ray detector 56,57 may have a sensitivity to a roughly 90-degree crescent-shape portion of the borehole, as shown in the shaded areas of FIG. 4. It will be appreciated, however, that the disclosed embodiments are expressly not limited to embodiments in which photoelectric factor measurements are made in four azimuthal sectors. As depicted, the region of sensitivity (e.g., the 90-degree crescent-shape space facing the gamma ray detector) generally includes both drilling fluid in the borehole annulus and rock formation. When no mud cake is formed on the borehole wall (generally a good assumption in LWD photoelectric logging) and the formation is homogeneous within the depth of investigation, the measured volumetric photoelectric factor Uₐ at azimuth α may be expressed, for example, as follows:

$${U}_{α} = {w}_{α} \cdot {U}_{m} + ( 1 - {w}_{α} ) \cdot {U}_{f} \qquad ( 1 )$$

where Uₘ and U_{f} represent the unknown volumetric photoelectric factors of the drilling fluid (the mud) and the formation surrounding the borehole and w_{α} represents a weighting fraction of drilling fluid (also referred to as a sensitivity factor) at azimuthal orientation α. It will be appreciated that the sensitivity w_{α} is related to the gamma ray detector standoff in the direction a and is generally a known quantity or a quantity that can be computed, for example, using a forward model including the physical dimensions of the logging tool, its configuration, and a measured standoff between the gamma ray detector and the borehole wall. In certain example embodiments, w_{α} values may be computed using a forward model. In other example embodiments, w_{α} values may be determined analytically from the area of the drilling fluid in the crescent-shape region of sensitivity described above. This drilling fluid area may be computed from standoff and caliper measurements (e.g., from the detector standoff and the borehole diameter). The analytical formula converting the drilling fluid area to w_{α} may be derived from the forward model and may include, for example, a fitting function such as a polynomial.

With continued reference to FIG. 4, when the logging tool is centered in the borehole (FIG. 4A), the weighting fraction w_{α} is generally independent of the azimuthal direction (since the standoff distance is independent of a). In such a configuration, it is not generally possible to solve Eq. (1) since a single equation includes two unknowns Uₘ and U_{f}. However, it will be appreciated that many, or even a majority, of LWD measurements are performed in a deviated or horizontal well in which the logging tool is eccentered near or at the bottom of the borehole owing to gravitational forces acting on the BHA (e.g., as depicted in FIG. 4B). A further aspect of the disclosed embodiments was the realization that such an eccentered configuration creates a severe asymmetry in w_{α}. It was still further realized that making photoelectric factor measurements in each of a plurality of (at least first and second) azimuthal sectors about the borehole may enable Uₘ and U_{f} to be estimated (e.g., computed). For example, when making azimuthal photoelectric factor measurements with an eccentered logging tool, Eq. (1) may be reconfigured and expressed as follows:

$${U}_{i} = {w}_{i} \cdot {U}_{m} + ( 1 - {w}_{i} ) \cdot {U}_{f} \qquad ( 2 )$$

where Uᵢ represent the plurality of photoelectric factor measurements and wᵢ represent the weighting fraction w_{α} in each azimuthal sector i, where i is greater than or equal to 2 such that i=1, . . . , N. It will be appreciated that Eq. (2) represents a system of at least first and second equations that may be solved simultaneously for the unknown Uₘ and U_{f} (e.g., a system including at least two equations and two unknowns).

In one example embodiment in which i=2, Eq. (2) may be expressed in matrix form as follows:

$$[ \begin{matrix}{U}_{u} \\ {U}_{b}\end{matrix} ] = [ \begin{matrix}{w}_{u} & 1 - {w}_{u} \\ {w}_{b} & 1 - {w}_{b}\end{matrix} ] [ \begin{matrix}{U}_{m} \\ {U}_{f}\end{matrix} ] \qquad ( 2 a )$$

Where Uᵤ and U_{b} represent the photoelectric factor measurements in upper and lower (bottom) sectors and the sub-indices u and b denote first and second, upper and lower azimuthal sectors of the borehole. Note that in Eq. (2a), the first and second equations (corresponding to the first and second independent photoelectric factor measurements) may be solved for the first and second unknowns Uₘ and U_{f} using mathematical techniques known to those or ordinary skill. In such an embodiment, wᵤ and w_{b} are known or may be estimated or computed from standoff and/or caliper measurements and the known logging tool configuration.

In another example embodiment in which i=4 (e.g., as depicted in FIG. 4B), Eq. (2) may be expressed in matrix form as follows:

$$[ \begin{matrix}{U}_{u} \\ {U}_{r} \\ {U}_{b} \\ {U}_{l}\end{matrix} ] = [ \begin{matrix}{w}_{u} & 1 - {w}_{u} \\ {w}_{r} & 1 - {w}_{r} \\ {w}_{b} & 1 - {w}_{b} \\ {w}_{l} & 1 - {w}_{l}\end{matrix} ] [ \begin{matrix}{U}_{m} \\ {U}_{f}\end{matrix} ] \qquad ( 2 b )$$

where the four sub-indices u, r, b, and l denote the four quadrants depicted on FIG. 4, namely the upper, right, bottom, and left quadrants. Note that Eq. (2b) is an overdetermined system that includes four distinct equations (corresponding to four distinct photoelectric factor measurements) that may be solved for the first and second unknowns, Uₘ and U_{f} using mathematical techniques known to those or ordinary skill. Note also that upper, right, bottom, and left quadrant sensitivities wᵤ, wᵣ, w_{b}, and wᵢ are known or can be estimated or computed from standoff and/or caliper measurements and the known logging tool configuration as described above.

With continued reference to FIG. 4 and Eqs. (2), (2a), and (2b), it will be appreciated that the disclosed embodiments are not limited to any particular azimuthal sector orientation provided that there are at least first and second azimuthal sectors having unequal weighting factors. For example, the azimuthal sectors may have substantially any azimuthal orientation in the borehole (such as upper and lower, left and right, or some other angled orientation with respect to the high side and low side of the borehole). Moreover, the azimuthal sectors are not necessarily the same size (i.e., do not necessarily subtend the same azimuthal angle). While the disclosed embodiments are not limited in this regard it may be advantageous to make use of azimuthal sectors that maximize a difference between the values of the weighting factors wᵢ (such as the difference between wᵤ and w_{b} in Eqs. (2a) and (2b)).

With continued reference to Eqs. (2), 2(a), and 2(b), it will be appreciated that the disclosed embodiments may be advantageously utilized in logging operations in which there is no mud cake on the borehole wall (e.g., such as is commonly observed in LWD operations), when the formation around the borehole is homogeneous such that the detector measures the same formation layers as the logging tool rotates in the borehole, and when the borehole wall is relatively smooth and rugosity is negligible. In such embodiments, the corrected photoelectric factor (e.g., including the photoelectric factor of the formation and the photoelectric factor of the drilling fluid) may be computed point by point (depth by depth) during a logging operation without the need for additional processing. In one alternative embodiment, e.g., in which the formation around the borehole is not homogenous, a log of the photoelectric factor sector measurements may be processed to depth align the measurements. In another alternative embodiment, e.g., in which the rugosity of the borehole wall is not negligible, a log of the photoelectric factor sector measurements may be processed with a median filter over a sliding depth window to remove noise caused by the borehole rugosity and other noise sources.

FIG. 5 depicts a flow chart of another example method 120 for obtaining a corrected photoelectric factor. Method 120 is similar to method 100 (FIG. 3) in that it includes rotating a logging tool in a borehole at 122 (e.g., while drilling). Gamma rays may be emitted into the borehole while rotating at 124 (e.g., via a Cesium-137 gamma ray source or another gamma ray or x-ray source). An azimuthal gamma ray image including at least first and second azimuthal sectors may be measured at 126. For example, the azimuthal gamma ray image may include a measured gamma ray count in each of the azimuthal sectors (such as a first gamma ray count in an upper sector and second gamma ray count in a lower sector or a first gamma ray count in an upper sector, a second gamma ray count in a right side sector, a third gamma ray count in a lower sector, and a fourth gamma ray count in a left side sector). The gamma ray counts in each of the azimuthal sectors may then be processed at 128 to compute a photoelectric factor (such as Pₑ or U) for each of the sectors. Method steps 126 and 128 may be repeated at 130 at any plurality of depths (e.g., while drilling or reaming) to obtain a photoelectric factor depth log. Selected ones of the computed photoelectric factor measurements may then be depth shifted at 132 to obtain a depth aligned (or depth corrected) log. The depth shifted log may then be further processed at each depth (e.g., depth by depth) at 134 (e.g., via one of Eqs. (2), 2(a), or 2(b)) to compute a corrected photoelectric factor including a first photoelectric factor of the formation surrounding the borehole and a second photoelectric factor of drilling fluid in the borehole.

With continued reference to FIG. 5 and further reference to FIG. 6, the depth shifting at 132 may be used to correct a depth mismatch between azimuthal sectors. It will be appreciated that in a deviated borehole, the depth at which a borehole intercepts a boundary layer depends on the azimuthal orientation about the periphery of the borehole. For example, the low side (e.g., the lower sector or quadrant) of the borehole may intercept a boundary layer at a smaller measured depth (a shallower depth) than the high side (e.g., the upper sector or quadrant) of the borehole. This is illustrated schematically in FIG. 6. In this example illustration, the logging tool 50 is inclined with respect to the boundary layer 48 by an angle φ (referred to as the relative dip). The low side and high side boundary layer intercepts are shown at 41 and 42. Note that the depth of the high side intercept is greater than the depth of the low side intercept by ΔMD, which may be expressed mathematically, for example, as follows:

$$Δ MD = \frac{d}{tan φ} \qquad ( 3 )$$

where d represents the outer diameter of the logging tool (or a corresponding stabilizer). It will be appreciated that ΔMD can be large in highly inclined (near horizontal) boreholes where φ and tan φ are very small. It will be further appreciated that ΔMD in Eq. (3) may be negative when φ is negative (i.e., when the boundary layer is approached from below) such that the depth of the high side intercept is less than the depth of the low side intercept by ΔMD.

In certain scenarios, such as in highly inclined boreholes, it may be beneficial to depth correct a log of the photoelectric factor image (or sectors) prior to computing the corrected photoelectric factor in 134. For example, in an embodiment including four azimuthal sectors (quadrants) as described above with respect to Eq. (2b), the upper sector may be depth shifted by −ΔMD while the left and right sectors may be depth shifted by −ΔMD/2. In such an embodiment, the depth of the lower sector is taken to be the reference depth. In another example, the upper sector may be depth shifted by −ΔMD/2 and the lower sector may be depth shifted by +ΔMD/2. In such an embodiment the depth of the left and right sectors is taken to the be the reference depth. The disclosed embodiments are, of course, not limited to any particular depth shifting technique or to the use of any particular reference depth. Moreover, it will be appreciated that the disclosed embodiments do not necessarily require the sector data to be depth shifted, for example, in embodiments in which the formation is essentially homogeneous, or in which bed boundaries are out of sensory range of the gamma ray measurements. In such embodiments, the corrected photoelectric factor may be computed depth by depth as the logging measurements are made.

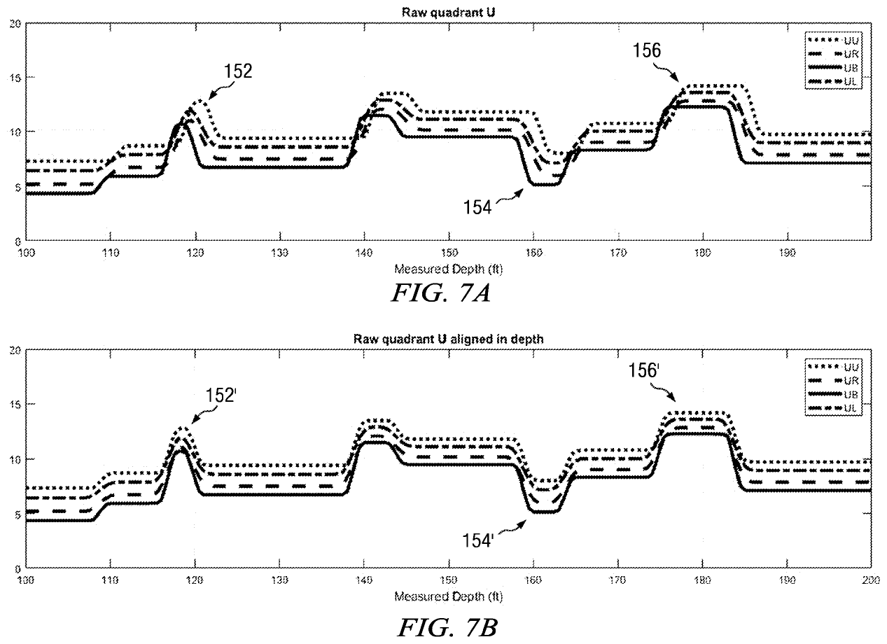

FIGS. 7A and 7B (collectively FIG. 7) depict plots of simulated raw volumetric photoelectric factor measurements versus depth (7A) and corresponding depth corrected (aligned) volumetric photelectric factor measurements (7B) for upper, right, bottom, and left quadrants. In this example, the simulated formation includes a number of bed boundaries as indicated at 152, 154, and 156. In FIG. 7A, the photoelectric factor sector logs are misaligned owing to a relative dip angle of 70 degrees between the borehole and the bed boundaries. Note that the bed boundaries are observed at a lower depth for the bottom sector (UB), a greater depth for upper sector (UU) and at an intermediate depth for the left (UL) and right (UR) sectors. FIG. 7B depicts a depth aligned (shifted) log that was obtained using the depth shifting technique described above. Note that the bed boundaries are observed at the same depths for each of the boundaries 152′, 154′, and 156′.

The disclosed embodiments are now described in more detail by way of the following non-limiting examples. In a first example, simulated photoelectric factor measurements were obtained for a Schlumberger EcoScope™ logging tool including an 8.25-inch (~21 cm) stabilizer. The tool was located at the bottom of a horizontal borehole surrounded by a homogeneous formation and rotated to make measurement in four azimuthal quadrants (upper, right, bottom, and left). Five formation types were simulated having different photoelectric factors created from various compositions of sand and carbonates. The U_{f} values for these formations were 4.34, 6.63, 8.92, 11.2, and 13.49, respectively. Twelve types of water-based drilling fluid were simulated with barite concentrations ranging from 0 ppk to 440 ppk, corresponding to Uₘ values ranging from 0.4 to about 160. Four borehole diameters were simulated, including 8.5-inch (~21.6 cm), 9-inch (~22.9 cm), 9.5-inch (~24.1 cm), and 10-inch (25.4 cm). Each simulation was characterized by one of the four borehole diameters, one of the twelve mud types, and one of the five formation types, for a total of 240 simulations. A forward model was used to simulate the quadrant measurements of U and Pₑ. Eq. 2(b) was then used to solve for Uₘ and U_{f}.

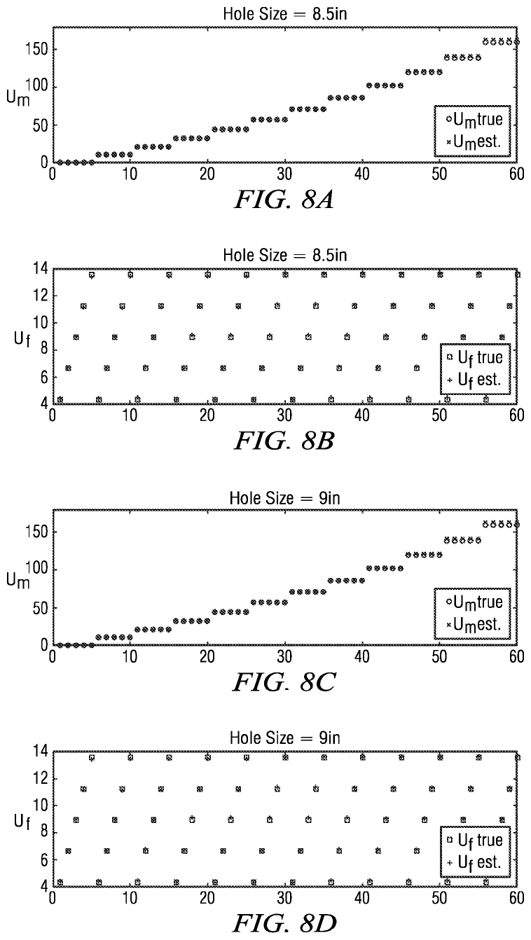

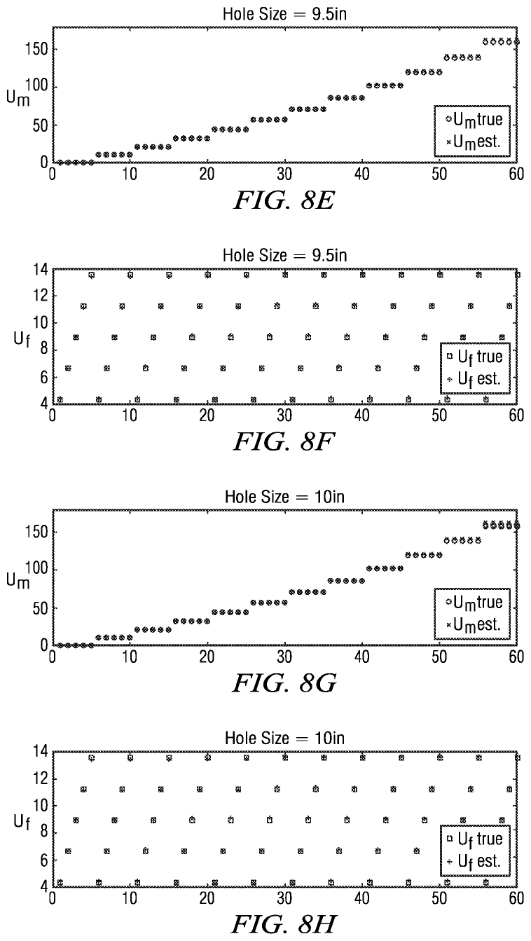

FIGS. 8A-8H depict the results of the simulations as plots of Uₘ versus simulation number (8A, 8C, 8E, and 8G) and U_{f} versus simulation number (8B, 8D, 8F, and 8H) for each of the four borehole sizes. Note that for each simulation the estimated photoelectric factor of the drilling fluid Uₘ and estimated photoelectric factor of the formation U_{f} matched the true values indicating the robustness of the method over a wide range of mud and formation photoelectric factor values and borehole diameters.

In a second example, simulated photoelectric factor measurements were also obtained for a Schlumberger EcoScope™ logging tool including an 8.25-inch (~21 cm) stabilizer. The tool was deployed in a high-angle borehole (70-degree inclination) traversing a layered formation. In this example, the borehole included water-based drilling fluid including 100 ppk barite with a density of 11.25 pounds per gallon, a mud Pₑ of 22.18, and Uₘ of 26.17. Three borehole diameters were simulated including 8.5, 9, and 10-inch (~21.6, 22.9, and 25.4 cm). Two different tool positions in the borehole were also simulated with tool contact points (points at which the tool contacted the borehole wall) of 180 degrees and 168.75 degrees (measured from high side). It will be appreciated that the 168.75-degree contact may be of significant practical significance as logging while drilling tools commonly contact the borehole wall slightly to the right of the bottom (i.e., at contact points just less than 180 degrees). Each simulation was characterized by one of the three borehole diameters and one of the two contact points for a total of 6 simulations. A forward model was used to simulate the quadrant measurements of U and Pₑ. The quadrant measurements were depth shifted as described above with respect to FIG. 6 and Eq. (3). The depth shifted measurements were then processed using Eq. 2 (b) to solve for Uₘ and U_{f} at each depth (depth by depth along the log).

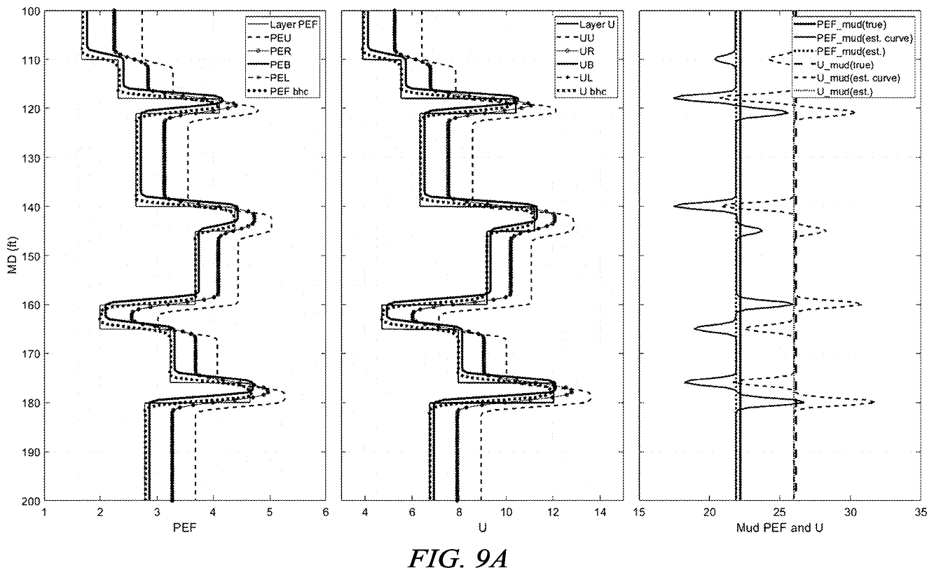

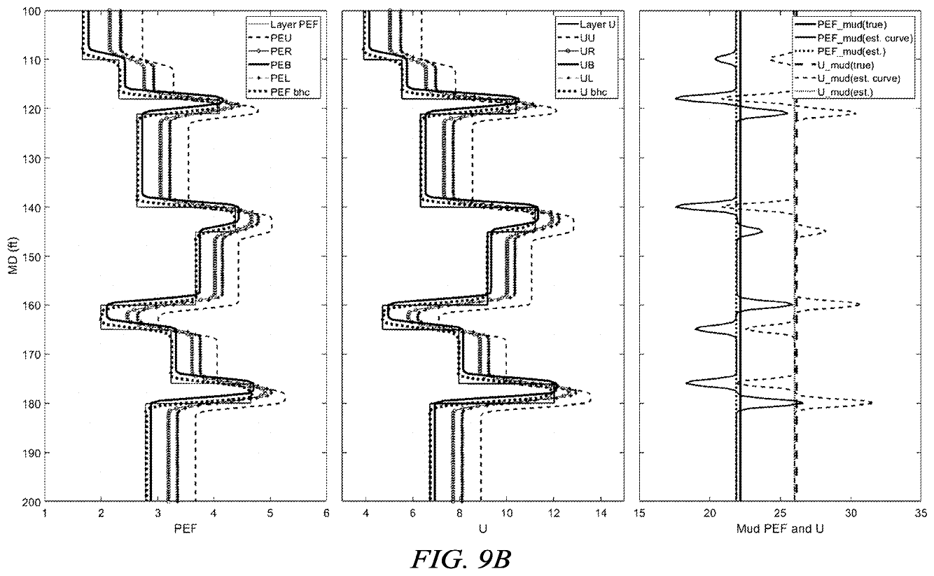

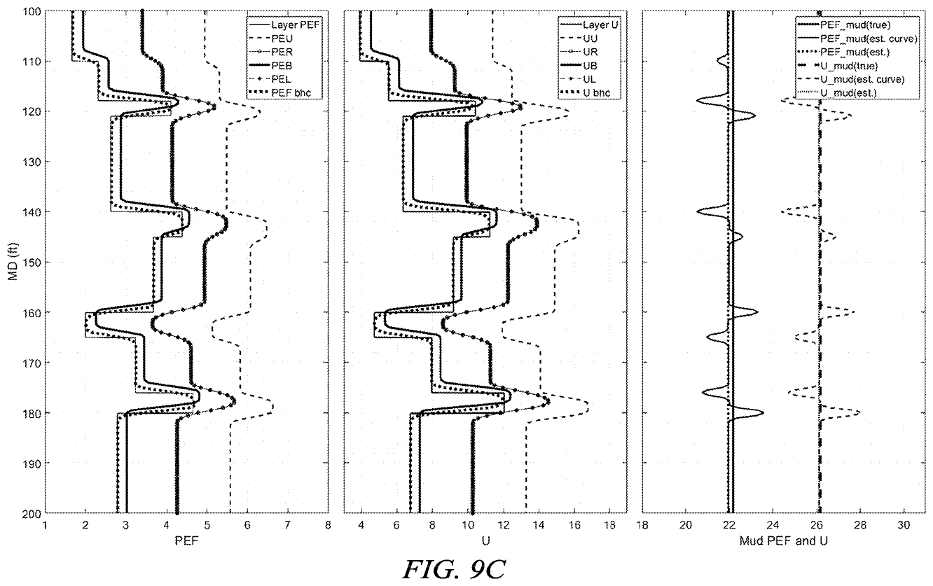

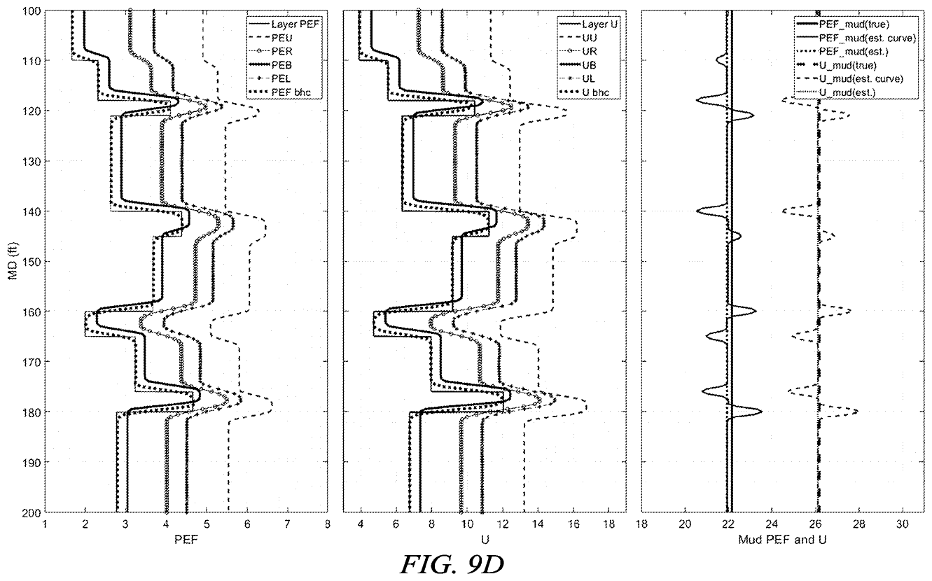

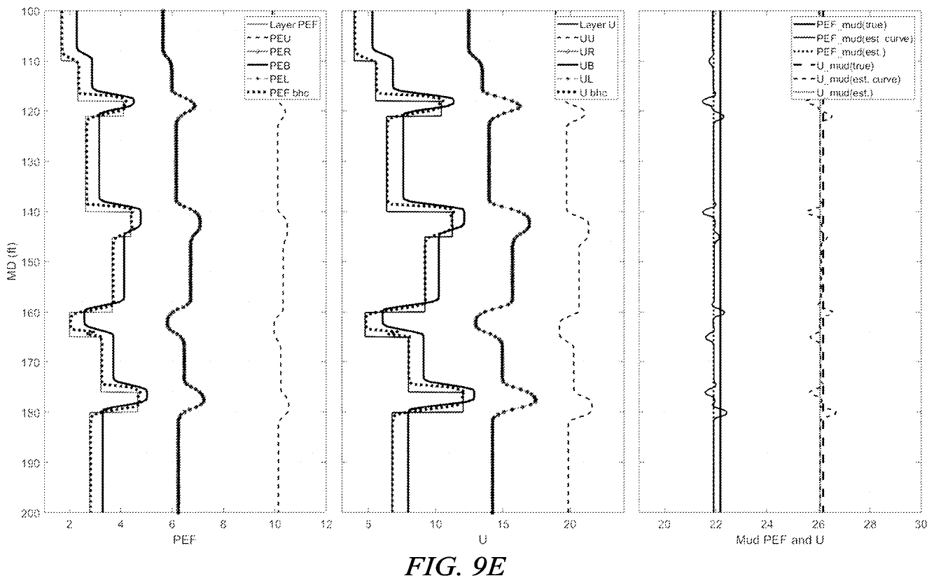

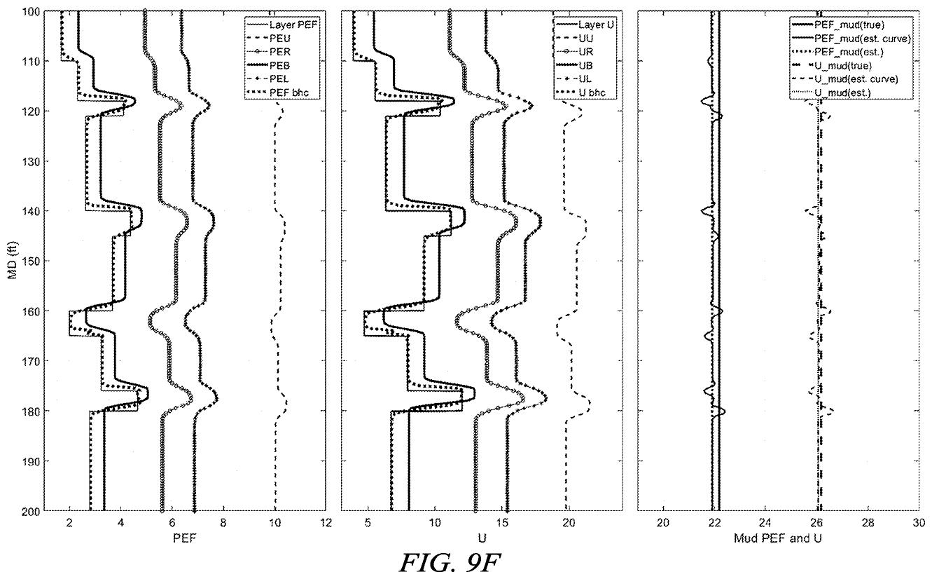

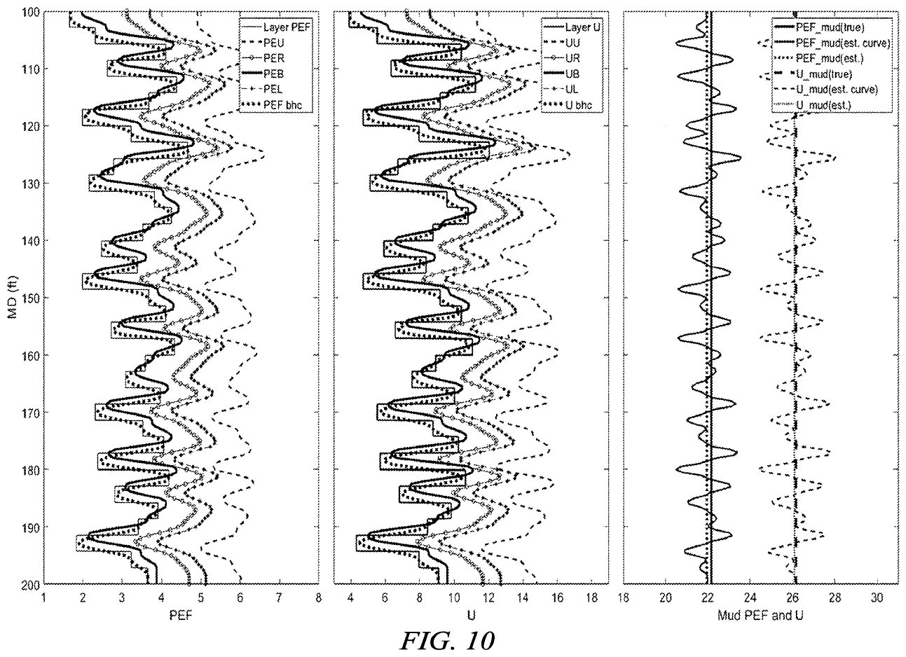

FIGS. 9A-9F depict the results of the simulations as logs of Pₑ, U, and mud Pₑ and U versus measured depth (MD). FIGS. 9A and 9B depict the simulations in an 8.5-inch (~21.6 cm) borehole with tool contact points at 180 and 168.75 degrees. FIGS. 9C and 9D depict the simulations in a 9-inch (~22.9 cm) borehole with tool contact points at 180 and 168.75 degrees. And FIGS. 9E and 9F depict the simulations in a 10-inch (~25.4 cm) borehole with tool contact points at 180 and 168.75 degrees. In each figure, the first track plots the photoelectric factor Pₑ versus measured depth, the second track plots the volumetric photoelectric factor U versus measured depth, and the third track plots the photoelectric factor and the volumetric photoelectric factor of the drilling fluid (mud) versus measured depth.

In the cases shown in FIGS. 9A and 9B where the tool was well engaged in the borehole, the measurements from the bottom quadrant where the tool contacted the borehole were close to the true formation values indicating that the effect of mud on the bottom quadrant measurements was minimal. Moreover, the left and right-side quadrant measurements were equal when the contact angle was 180 degrees and deviated from one another when contact angle was 168.75 degrees. With the exception of a very thin layer (about 20 cm) at a measured depth of 120 feet (~35 m), the borehole correction worked well in both simulations showing good agreement between the corrected measurements (dotted lines in the first and second tracks) and the corresponding true formation properties (thin-solid lines in the first and second tracks).

The third track shows the computed properties of the borehole mud. The thick-solid and thick-dashed lines indicate the true value of mud Pₑ and U, respectively. The thinner solid and dashed lines indicate estimated mud Pₑ and U values determined from a point by point correction. Though the mud properties were constant in the simulation, the estimated curves may deviate from the true values at the transition depths from one layer to another. Computing median values of each of the boundary-distorted curves gave an estimated of constant Pₑ and U values (dotted lines) that agree well with the corresponding true mud properties. In a logging while drilling implementation in which barite concentration in the drilling fluid may change while drilling, a median filter may be applied over a sliding depth window to estimate the true mud properties.

FIGS. 9C and 9D depict simulations in the 9-inch (~22.9 cm) borehole. The effect of the drilling fluid became more significant (than in the 8.5-inch (~21.6 cm) borehole) owing to the enlarged borehole volume. In both simulations, the bottom quadrant Pₑ and U measurements were significantly greater than the true formation values. However, as further indicated in the first and second tracks, the corrected Pₑ and U measurements were in good agreement with the true values. Note also that in the third track the mud Pₑ and U were accurately estimated.

FIGS. 9E and 9F depict simulations in the 10-inch (~25.4 cm) borehole. It will be appreciated that this scenario may be impractical as a larger stabilizer (e.g., 9⅜-inch (~23.8 cm)) would generally be used in a 10-inch (~25.4 cm) diameter borehole. Notwithstanding, despite the significantly increased contribution of the drilling fluid, the corrected Pₑ and U measurements were in good agreement with the true values as indicated in the first and second tracks. Note also that in the third track the mud Pₑ and U were accurately estimated, even without the use of the median filter.

FIG. 10 depicts the results of a third example. In this third example, simulated photoelectric factor measurements were also obtained for a Schlumberger EcoScope® logging tool including an 8.25-inch (~21 cm) stabilizer. The tool was deployed in a 9-inch (~22.9 cm) diameter high angle borehole (70-degree inclination) traversing a layered formation having a large number of thin layers (each layer was less than 1 ft (~30 cm) thick). The borehole included water-based drilling fluid having 100 ppk barite with a mud Pₑ of 22.18, and a Uₘ of 26.17. The contact point between the tool and the borehole was at 168.75 degrees. The first, second, and third tracks are identical to those described above. Note that the measurements at most depth points reflect transitions from one layer to another. Notwithstanding, the corrected measurements gave a reasonable estimation of the true formation properties (e.g., at the maxima, minima, and inflection points of the curve). Moreover, the mud properties were accurately identified using the median filtering technique described above.

It will be understood that the present disclosure includes numerous embodiments. These embodiments include, but are not limited to, the following embodiments.

In a first embodiment, a method for correcting photoelectric logging measurements comprises acquiring a photoelectric factor image, the photoelectric factor image including a photoelectric factor measurement in each of at least first and second azimuthal sectors in a borehole; and processing a system of equations that relates the acquired photoelectric factor image to a photoelectric factor of a formation through which the borehole penetrates and a photoelectric factor of drilling fluid in the borehole to compute the photoelectric factor of the formation and photoelectric factor of the drilling fluid.

A second embodiment may include the first embodiment, wherein the acquiring the photoelectric factor image comprises: rotating a logging tool in the borehole, the logging tool including a gamma ray source and at least one gamma ray detector; emitting gamma rays into the borehole using the gamma ray source while the logging tool rotates in the borehole; causing the at least one gamma ray detector to detect gamma rays corresponding to the emitted gamma rays; and processing the detected gamma rays to compute the photoelectric factor image of the borehole.

A third embodiment may include the second embodiment, wherein the borehole is a deviated borehole; and rotating the logging tool comprises rotating the logging tool in the deviated borehole such that the logging tool is eccentered in the deviated borehole.

A fourth embodiment may include any one of the second through third embodiments, further comprising measuring an azimuth of the gamma ray detector while the logging tool rotates in the borehole; processing the measured azimuth and the detected gamma rays to bin the detected gamma rays in the at least first and second azimuthal sectors; and processing the binned gamma rays to compute the photoelectric factor image.

A fifth embodiment may include any one of the second through fourth embodiments, further comprising measuring a borehole caliper or a standoff of the gamma ray detector from a wall of the borehole.

A sixth embodiment may include the fifth embodiment, further comprising processing the borehole caliper or the standoff to compute a weighting fraction of the drilling fluid for each of the at least first and second azimuthal sectors.

A seventh embodiment may include the sixth embodiment, wherein the system of equations relates the computed photoelectric factor image to the weighting fraction of the drilling fluid for each of the at least first and second azimuthal sectors, the photoelectric factor of the formation, and the photoelectric factor of the drilling fluid.

An eighth embodiment may include the seventh embodiment, wherein the system of equations comprises:

$${U}_{i} = {w}_{i} \cdot {U}_{m} + ( 1 - {w}_{i} ) \cdot {U}_{f}$$

wherein Uᵢ represents the photelectric factor image, wᵢ represent the weighting fractions, the index i represents the at least first and second azimuthal sectors, U_{f} represents the photoelectric factor of the formation, and Uₘ represents the photoelectric factor of the drilling fluid.

A ninth embodiment may include any one of the first through eighth embodiments, wherein the photoelectric factor comprises at least one of a photoelectric factor pₑ and a volumetric photoelectric factor U.

A tenth embodiment may include any one of the first through ninth embodiments, wherein the photoelectric factor image includes at least first, second, third, and fourth azimuthal sectors.

In an eleventh embodiment, a logging tool comprises a logging tool body; a gamma ray source in the logging tool body; at least one gamma ray detector spaced apart from the gamma ray source in the logging tool body; and a processor configured to cause the at least one gamma ray detector to detect gamma rays corresponding to gamma rays emitted by the gamma ray source while the logging tool rotates in a borehole; process the detected gamma rays to compute a photoelectric factor image including a photoelectric factor measurement in each of at least first and second azimuthal sectors in the borehole; and process a system of equations that relates the photoelectric factor image to a photoelectric factor of a formation through which the borehole penetrates and a photoelectric factor of drilling fluid in the borehole to compute the photoelectric factor of the formation and the photoelectric factor of the drilling fluid.

A twelfth embodiment may include the eleventh embodiment, further comprising an azimuth sensor configured to measure an azimuth of the at least one gamma ray detector in the borehole, wherein the processor is further configured to process the measured azimuth and the detected gamma rays to bin the detected gamma rays in the at least first and second azimuthal sectors and process the binned gamma rays to compute the photoelectric factor image.

A thirteenth embodiment may include any one of the eleventh through twelfth embodiments, further comprising an ultrasonic standoff sensor configured to measure at least one of a borehole caliper or a standoff distance between the at least one gamma ray detector and a borehole wall, wherein the processor is further configured to process the borehole caliper or the standoff distance to compute a weighting fraction of the drilling fluid for each of the at least first and second azimuthal sectors, wherein the system of equations relates the computed photoelectric factor image to the weighting fraction of the drilling fluid for each of the at least first and second azimuthal sectors, the photoelectric factor of the formation, and the photoelectric factor of the drilling fluid.

A fourteenth embodiment may include any one of the eleventh through thirteenth embodiments, wherein the processor is further configured to repeat the cause the at least one gamma ray detector to detect gamma rays and the process the detected gamma rays at a plurality of depths in the borehole to generate a photoelectric factor image log; depth shift the photoelectric factor measurements in at least one of the at least first and second azimuthal sectors in the log to generate a depth shifted log; and process the depth shifted log at each of the plurality of depths to generate a log of the photoelectric factor of the formation and a log of the photoelectric factor of the drilling fluid.

A fifteenth embodiment may include any one of the eleventh through fourteenth embodiments, wherein the gamma ray source comprises a Cesium-137 gamma ray source; and the at least one gamma ray detector comprises a sodium iodide scintillator crystal and a photomultiplier.

In a sixteenth embodiment a method for making borehole corrected photoelectric logging measurements comprises rotating a logging tool in a deviated borehole such that the logging tool is eccentered in the deviated borehole, the logging tool including a gamma ray source and at least one gamma ray detector, the borehole including drilling fluid therein and penetrating a formation; emitting gamma rays into the deviated borehole using the gamma ray source while the logging tool rotates in the deviated borehole; causing the at least one gamma ray detector to detect gamma rays corresponding to the emitted gamma rays; processing the detected gamma rays to compute a photoelectric factor image including a photoelectric factor measurement in at least first and second azimuthal sectors in the borehole; repeating the causing the at least one gamma ray detector to detect gamma rays and the processing the detected gamma rays at a plurality of depths in the borehole to generate a log including a photoelectric factor image at each of the plurality of depths; depth shifting the photoelectric factor measurements in at least one of the first and second azimuthal sectors in the log to generate a depth shifted log; and processing a system of equations that relates the depth shifted log at each of the plurality of depths to a photoelectric factor of the formation and a photoelectric factor of the drilling fluid to compute a log of the photoelectric factor of the formation and a log of the photoelectric factor of the drilling fluid.

A seventeenth embodiment may include the sixteenth embodiment, further comprising processing the log of the photoelectric factor of the drilling fluid at selected ones of the plurality of depths to compute a median photoelectric factor of the drilling fluid.

An eighteenth embodiment may include any one of the sixteenth through seventeenth embodiments, wherein the at least first and second azimuthal sectors comprise an upper sector, a right sector, a bottom sector, and a left sector.

A nineteenth embodiment may include any one of the sixteenth through eighteenth embodiments, further comprising measuring a borehole caliper or a standoff of the gamma ray detector from a wall of the borehole; and processing the borehole caliper or the standoff to compute a weighting fraction of the drilling fluid for each of the at least first and second azimuthal sectors.

A twentieth embodiment may include any one of the sixteenth through nineteenth embodiments, wherein the system of equations comprises:

$${U}_{i} = {w}_{i} \cdot {U}_{m} + ( 1 - {w}_{i} ) \cdot {U}_{f}$$

wherein Uᵢ represents the photelectric factor image, wᵢ represent the weighting fraction of the drilling fluid, the index i represents the at least first and second azimuthal sectors, U_{f} represents the photoelectric factor of the formation, and Uₘ represents the photoelectric factor of the drilling fluid.

Although borehole correction of formation photoelectric factors has been described in detail, it should be understood that various changes, substitutions and alternations can be made herein without departing from the spirit and scope of the disclosure as defined by the appended claims.

What is claimed is:

1. A method for correcting photoelectric logging measurements, the method comprising:
acquiring a photoelectric factor image, the photoelectric factor image including a photoelectric factor measurement in each of at least first and second azimuthal sectors in a borehole; and
processing a system of equations that relates the acquired photoelectric factor image to a photoelectric factor of a formation through which the borehole penetrates and a photoelectric factor of drilling fluid in the borehole to compute the photoelectric factor of the formation and photoelectric factor of the drilling fluid.

2. The method of claim 1, wherein the acquiring the photoelectric factor image comprises:
rotating a logging tool in the borehole, the logging tool including a gamma ray source and at least one gamma ray detector;
emitting gamma rays into the borehole using the gamma ray source while the logging tool rotates in the borehole;
causing the at least one gamma ray detector to detect gamma rays corresponding to the emitted gamma rays; and
processing the detected gamma rays to compute the photoelectric factor image of the borehole.

3. The method of claim 2, wherein:
the borehole is a deviated borehole; and
rotating the logging tool comprises rotating the logging tool in the deviated borehole such that the logging tool is eccentered in the deviated borehole.

4. The method of claim 2, further comprising:
measuring an azimuth of the gamma ray detector while the logging tool rotates in the borehole;
processing the measured azimuth and the detected gamma rays to bin the detected gamma rays in the at least first and second azimuthal sectors; and
processing the binned gamma rays to compute the photoelectric factor image.

5. The method of claim 2, further comprising measuring a borehole caliper or a standoff of the gamma ray detector from a wall of the borehole.

6. The method of claim 5, further comprising processing the borehole caliper or the standoff to compute a weighting fraction of the drilling fluid for each of the at least first and second azimuthal sectors.

7. The method of claim 6, wherein the system of equations relates the computed photoelectric factor image to the weighting fraction of the drilling fluid for each of the at least first and second azimuthal sectors, the photoelectric factor of the formation, and the photoelectric factor of the drilling fluid.

8. The method of claim 7, wherein the system of equations comprises:
$${U}_{i} = {w}_{i} \cdot {U}_{m} + ( 1 - {w}_{i} ) \cdot {U}_{f}$$
wherein Uᵢ represents the photelectric factor image, wᵢ represent the weighting fractions, the index i represents the at least first and second azimuthal sectors, U_{f} represents the photoelectric factor of the formation, and Uₘ represents the photoelectric factor of the drilling fluid.

9. The method of claim 1, wherein the photoelectric factor comprises at least one of a photoelectric factor pₑ and a volumetric photoelectric factor U.

10. The method of claim 1, wherein the photoelectric factor image includes at least first, second, third, and fourth azimuthal sectors.

11. A logging tool comprising:
a logging tool body;
a gamma ray source in the logging tool body;
at least one gamma ray detector spaced apart from the gamma ray source in the logging tool body; and
a processor configured to:
cause the at least one gamma ray detector to detect gamma rays corresponding to gamma rays emitted by the gamma ray source while the logging tool rotates in a borehole;
process the detected gamma rays to compute a photoelectric factor image including a photoelectric factor measurement in each of at least first and second azimuthal sectors in the borehole; and
process a system of equations that relates the photoelectric factor image to a photoelectric factor of a formation through which the borehole penetrates and a photoelectric factor of drilling fluid in the borehole to compute the photoelectric factor of the formation and the photoelectric factor of the drilling fluid.

12. The logging tool of claim 11, further comprising an azimuth sensor configured to measure an azimuth of the at least one gamma ray detector in the borehole, wherein the processor is further configured to process the measured azimuth and the detected gamma rays to bin the detected gamma rays in the at least first and second azimuthal sectors and process the binned gamma rays to compute the photoelectric factor image.

13. The logging tool of claim 11, further comprising an ultrasonic standoff sensor configured to measure at least one of a borehole caliper or a standoff distance between the at least one gamma ray detector and a borehole wall, wherein the processor is further configured to process the borehole caliper or the standoff distance to compute a weighting fraction of the drilling fluid for each of the at least first and second azimuthal sectors, wherein the system of equations relates the computed photoelectric factor image to the weighting fraction of the drilling fluid for each of the at least first and second azimuthal sectors, the photoelectric factor of the formation, and the photoelectric factor of the drilling fluid.

14. The logging tool of claim 11, wherein the processor is further configured to:
repeat the cause the at least one gamma ray detector to detect gamma rays and the process the detected gamma rays at a plurality of depths in the borehole to generate a photoelectric factor image log;
depth shift the photoelectric factor measurements in at least one of the at least first and second azimuthal sectors in the log to generate a depth shifted log; and
process the depth shifted log at each of the plurality of depths to generate a log of the photoelectric factor of the formation and a log of the photoelectric factor of the drilling fluid.

15. The logging tool of claim 11, wherein:
the gamma ray source comprises a Cesium-137 gamma ray source; and
the at least one gamma ray detector comprises a sodium iodide scintillator crystal and a photomultiplier.

16. A method for making borehole corrected photoelectric logging measurements, the method comprising:
rotating a logging tool in a deviated borehole such that the logging tool is eccentered in the deviated borehole, the logging tool including a gamma ray source and at least one gamma ray detector, the borehole including drilling fluid therein and penetrating a formation;
emitting gamma rays into the deviated borehole using the gamma ray source while the logging tool rotates in the deviated borehole;
causing the at least one gamma ray detector to detect gamma rays corresponding to the emitted gamma rays;
processing the detected gamma rays to compute a photoelectric factor image including a photoelectric factor measurement in at least first and second azimuthal sectors in the borehole;
repeating the causing the at least one gamma ray detector to detect gamma rays and the processing the detected gamma rays at a plurality of depths in the borehole to generate a log including a photoelectric factor image at each of the plurality of depths;
depth shifting the photoelectric factor measurements in at least one of the first and second azimuthal sectors in the log to generate a depth shifted log; and
processing a system of equations that relates the depth shifted log at each of the plurality of depths to a photoelectric factor of the formation and a photoelectric factor of the drilling fluid to compute a log of the photoelectric factor of the formation and a log of the photoelectric factor of the drilling fluid.

17. The method of claim 16, further comprising processing the log of the photoelectric factor of the drilling fluid at selected ones of the plurality of depths to compute a median photoelectric factor of the drilling fluid.

18. The method of claim 16, wherein the at least first and second azimuthal sectors comprise an upper sector, a right sector, a bottom sector, and a left sector.

19. The method of claim 16, further comprising:
measuring a borehole caliper or a standoff of the gamma ray detector from a wall of the borehole; and
processing the borehole caliper or the standoff to compute a weighting fraction of the drilling fluid for each of the at least first and second azimuthal sectors.

20. The method of claim 19, wherein the system of equations comprises:
$${U}_{i} = {w}_{i} \cdot {U}_{m} + ( 1 - {w}_{i} ) \cdot {U}_{f}$$
wherein Uᵢ represents the photelectric factor image, wᵢ represent the weighting fraction of the drilling fluid, the index i represents the at least first and second azimuthal sectors, U_{f} represents the photoelectric factor of the formation, and Uₘ represents the photoelectric factor of the drilling fluid.
